(19) United States
(12) Patent Application Publication
(10) Pub. No.: US 2021/0300261 A1
(43) Pub. Date: Sep. 30, 2021

(54) IMAGING UNIT FOR VEHICLE

(71) Applicant: HONDA MOTOR CO., LTD., Minato-ku, Tokyo (JP)

(72) Inventor: Makoto Sawada, Wako-shi (JP)

(21) Appl. No.: 17/257,869

(22) PCT Filed: Aug. 28, 2018
(86) PCT No.: PCT/JP2018/031719

§ 371 Date: Jan. 5, 2021

(51) Int. Cl. B60R 11/04; H04N 5/225; B60R 11/02

(52) U.S. Cl. CPC B60R 11/04; H04N 5/2254; B60R 2011/004; H04N 5/2252; B60R 11/0235

(57) ABSTRACT

An imaging unit for a vehicle includes a rearward imaging device, a downward imaging device, and a housing. The rearward imaging device images a lateral rearward side of the vehicle. The downward imaging device images a lateral downward side of the vehicle. The rearward imaging device and the downward imaging device are housed in the housing, which is attached to a side portion of a vehicle body. The rearward imaging device is located on a rear side of the vehicle with respect to the downward imaging device and is disposed inside the housing such that an outer end of the imaging lens in the vehicle width direction is located outside the downward imaging device in the vehicle width direction.

### TECHNICAL FIELD

The present invention relates to an imaging unit for a vehicle including a rearward imaging device that images a lateral rearward side of the vehicle.

### BACKGROUND ART

A device in which an imaging unit (a camera) having a rearward imaging device that images a lateral rearward side of a vehicle is integrated with a monitor that displays an image captured by the imaging device, and the integrated monitor unit is attached to a front triangular window portion of a front side door is known (see Patent Literature 1).

In the monitor unit described in Patent Literature 1, in a state in which the monitor unit is attached to the triangular window portion of the front side door, the monitor is disposed inside an interior of the vehicle, and the imaging unit is disposed outside an interior of the vehicle. An imaging lens of the imaging unit is installed on a rear surface of a housing such that an optical axis thereof faces the lateral rearward side of the vehicle.

### CITATION LIST

### Patent Literature

### [Patent Literature 1]

PCT International Publication No. WO 2011/105638

### SUMMARY OF INVENTION

### Technical Problem

In the monitor unit described in Patent Literature 1, only the rearward imaging device that images the lateral rearward side of the vehicle is housed in the imaging unit disposed outside the vehicle. Currently, it is desired to devise an imaging unit having not only an imaging function for a lateral rearward side of a vehicle but also an imaging function for a lateral downward side of a vehicle. In this case, it is necessary for the imaging unit to suppress mutual reflection of imaging devices and to make the housing compact without limiting the imaging function of the rearward imaging device for a region including a rearward far side of the vehicle.

An object is to provide an imaging unit for a vehicle capable of compactly housing a rearward imaging device and a lateral imaging device in a housing without limiting functions of the imaging devices.

### Solution to Problem

An imaging unit for a vehicle according to the present invention includes a rearward imaging device that images a lateral rearward side of the vehicle; a downward imaging device that images a lateral downward side of the vehicle; and a housing in which the rearward imaging device and the downward imaging device are housed and that is attached to a side portion of a vehicle body, wherein the rearward imaging device is located on a rear side of the vehicle with respect to the downward imaging device and is disposed inside the housing such that an outer end of an imaging lens in a vehicle width direction is located outside the downward imaging device in the vehicle width direction.

In the imaging unit for a vehicle, since the rearward imaging device and the downward imaging device are disposed in one housing, the number of components can be reduced and the unit can be downsized.

Further, in the imaging unit for a vehicle, the rearward imaging device is disposed on a rear side of the vehicle with respect to the downward imaging device and is disposed such that an outer end of an imaging lens in a vehicle width direction is located outside the downward imaging device in the vehicle width direction. Therefore, it is possible to suppress mutual reflection of both imaging devices and to make the housing compact in the vehicle width direction. Further, it is possible to suppress reflection of the own vehicle by the rearward imaging device and to image a region including a rearward far side of the vehicle by the rearward imaging device.

The rearward imaging device and the downward imaging device may be disposed in the housing such that, in a state in which the housing is attached to the side portion of the vehicle body, center positions of both device main bodies are substantially horizontal.

In this case, a thickness of the housing in the vertical direction can be reduced and traveling resistance of the housing can be reduced.

A lamp unit that emits light to the outside may be attached to an outer portion of the housing in the vehicle width direction.

In this case, since the lamp unit is disposed in one housing of the imaging unit for a vehicle together with the rearward imaging device and the downward imaging device in an integrative manner, the number of components can be further reduced and the unit can be further downsized.

The lamp unit may be attached to the housing such that, in a state in which the housing is attached to the side portion of the vehicle body, a center position of the lamp unit in the vertical direction is substantially horizontal to center positions of device main bodies of the rearward imaging device and the downward imaging device.

In this case, the thickness of the housing in the vertical direction can be reduced and the traveling resistance of the housing can be reduced, while the lamp unit is incorporated in one housing together with the rearward imaging device and the downward imaging device.

An outer surface of the housing may have an inclined region that extends to be inclined outward in the vehicle width direction from a front end position close to a vehicle body side surface toward a rear side of the vehicle body, the lamp unit may have an inclined portion that is disposed in the housing substantially along the inclined region, and the downward imaging device may be disposed at a position inside the inclined portion in the vehicle width direction.

In this case, since the inclined region is provided on the front side of the housing, the traveling resistance of the housing can be reduced when the vehicle travels. Further, the inclined portion of the lamp unit is disposed substantially along the inclined region of the housing. Therefore, an internal space of the housing is compressed by the inclined portion of the lamp unit. Meanwhile, since the downward imaging device that is disposed inside the inclined portion in the vehicle width direction is disposed inside in the vehicle width direction with respect to the outer end of the imaging lens of the rearward imaging device in the vehicle width direction, interference between the inclined portion and the downward imaging device can be easily avoided.

The downward imaging device may be disposed inside the housing such that an imaging lens is inclined outward in the vehicle width direction and downward from the device main body.

In this case, since the imaging lens is inclined outward in the vehicle width direction and downward from the device main body, interference between the imaging lens of the downward imaging device and the inclined portion of the lamp unit can be more easily avoided.

### Advantageous Effects of Invention

In the imaging unit for a vehicle of the present invention, the rearward imaging device is located on a rear side of the vehicle with respect to the downward imaging device and is disposed inside the housing such that an outer end of the imaging lens in the vehicle width direction is located outside the downward imaging device in the vehicle width direction. Therefore, in the imaging unit for a vehicle of the present invention, it is possible to suppress mutual reflection of the rearward imaging device and the downward imaging device, to make the housing compact in the vehicle width direction, to suppress reflection of the own vehicle by the rearward imaging device, and to image a region including a rearward far side of the vehicle by the rearward imaging device.

Therefore, according to the imaging unit for a vehicle of the present invention, it is possible to compactly house the rearward imaging device and the lateral imaging device in a housing without limiting functions of the imaging devices.

### BRIEF DESCRIPTION OF DRAWINGS

FIG. 1 is a perspective view showing an interior of a vehicle according to an embodiment of the present invention.

FIG. 2 is a side view of the vehicle according to the embodiment of the present invention.

FIG. 3 is a top view of the vehicle according to the embodiment of the present invention.

FIG. 4 is a front view of the vehicle according to the embodiment of the present invention.

FIG. 5 is a rear view of the vehicle according to the embodiment of the present invention.

FIG. 6 is a diagram showing a display on a monitor of a rearward side display system according to the embodiment of the present invention.

FIG. 7 is a top view of an imaging unit according to the embodiment of the present invention.

FIG. 8 is a bottom view of the imaging unit according to the embodiment of the present invention.

FIG. 9 is a front view of the imaging unit according to the embodiment of the present invention.

FIG. 10 is a side view of the imaging unit according to the embodiment of the present invention.

FIG. 11 is a rear view of the imaging unit according to the embodiment of the present invention.

FIG. 12 is a perspective view of the imaging unit according to the embodiment of the present invention.

FIG. 13 is a cross-sectional view along line XIII-XIII of FIG. 11 of the imaging unit according to the embodiment of the present invention.

FIG. 14 is a cross-sectional view along line XIV-XIV of FIG. 11 of the imaging unit according to the embodiment of the present invention.

### DESCRIPTION OF EMBODIMENTS

Hereinafter, an embodiment of the present invention will be described with reference to the drawings. In the following description, front, rear, top, bottom, left, and right are front, rear, top, bottom, left, and right of a vehicle unless otherwise specified. Further, in appropriate places in the drawings, an arrow UP pointing upward with respect to the vehicle, an arrow FR pointing forward with respect to the vehicle, and an arrow LH pointing left with respect to the vehicle are shown.

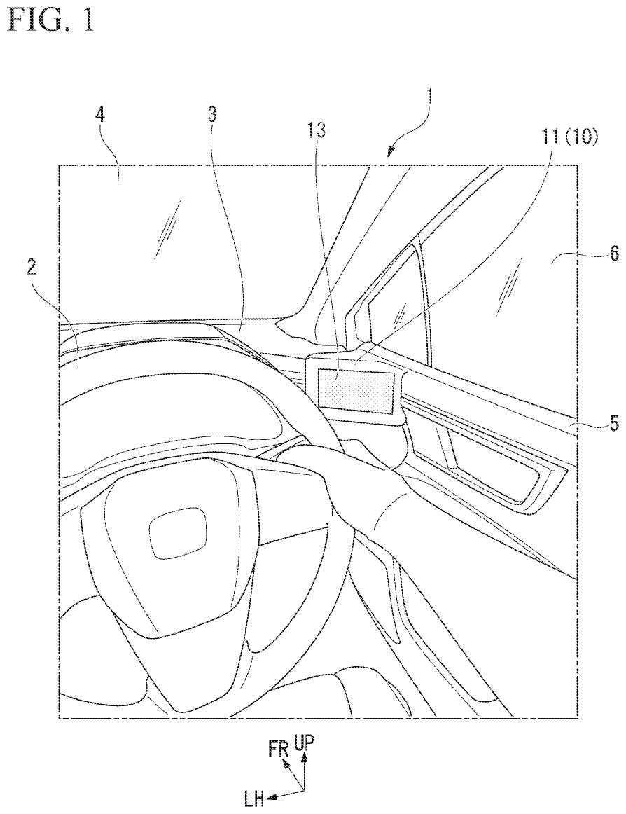

FIG. 1 is a view showing an interior of a vehicle 1 of the embodiment. FIG. 1 is a view of a front side of front seats (a driver seat and a passenger seat) of the vehicle when seen diagonally from a rear upper side.

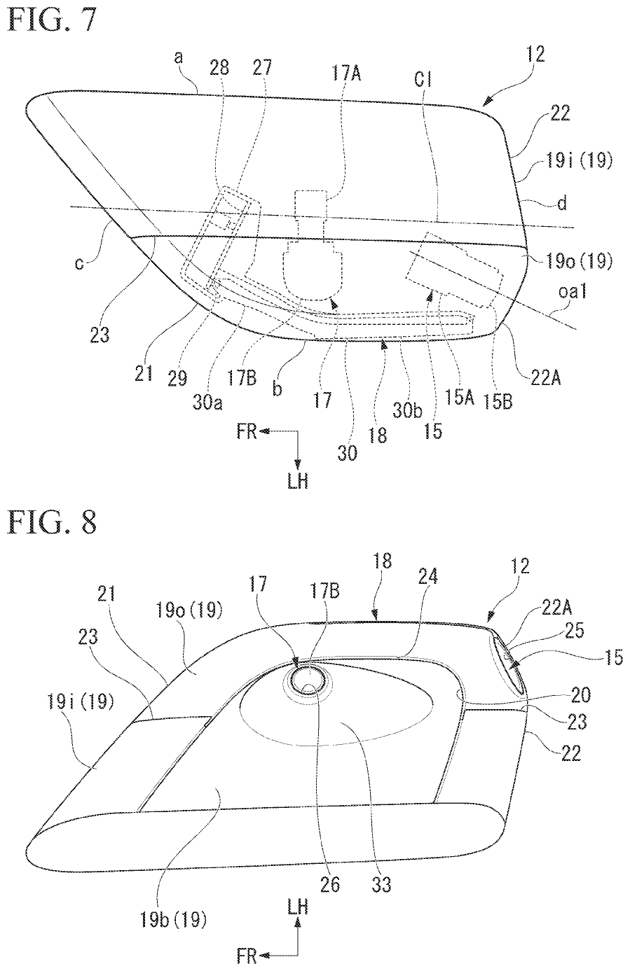

Reference numeral 2 in FIG. 1 is a steering wheel disposed in front of the driver seat (not shown), reference numeral 3 is an instrument panel, reference numeral 4 is a windshield glass in front of the vehicle interior, and reference numeral 5 is a front side door (a side door) on a driver seat side. Further, reference numeral 6 is a door glass provided on the front side door 5 to be able to move up and down. The vehicle 1 of the present embodiment is equipped with a rearward side display system 10 that displays a lateral rearward side of the vehicle in the vehicle interior. The rearward side display system 10 images left and right rearward sides of the vehicle with a rearward imaging device 15 (an imaging device; see FIG. 7 and the like), and displays the captured image on a monitor 11 (a display device) in the vehicle interior.

The rearward side display system 10 includes rearward imaging devices 15 disposed outside the left and right front side doors 5, a pair of monitors 11 installed in the vehicle interior corresponding to the left and right rearward imaging devices 15, and a control device (not shown) that controls the rearward imaging devices 15 and the monitors 11. The monitors 11 corresponding to the left and right rearward imaging devices 15 are installed near lower ends of left and right front pillars 7 in the vehicle interior. An image of the left rearward side of the vehicle is displayed on the monitor 11 at the lower end of the left front pillar 7, and an image of the right rearward side of the vehicle is displayed on the monitor 11 at the lower end of the right front pillar 7.

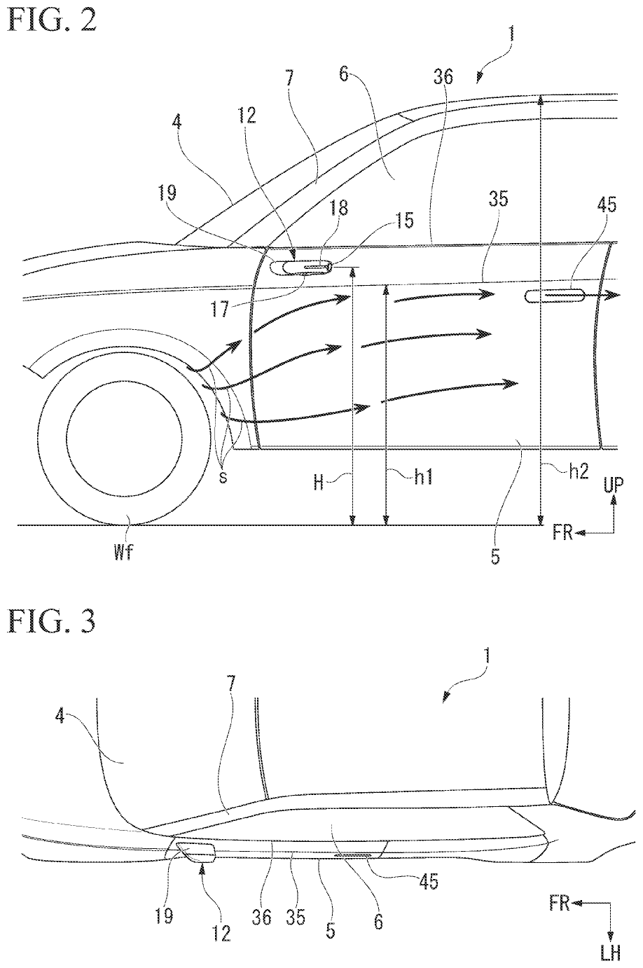

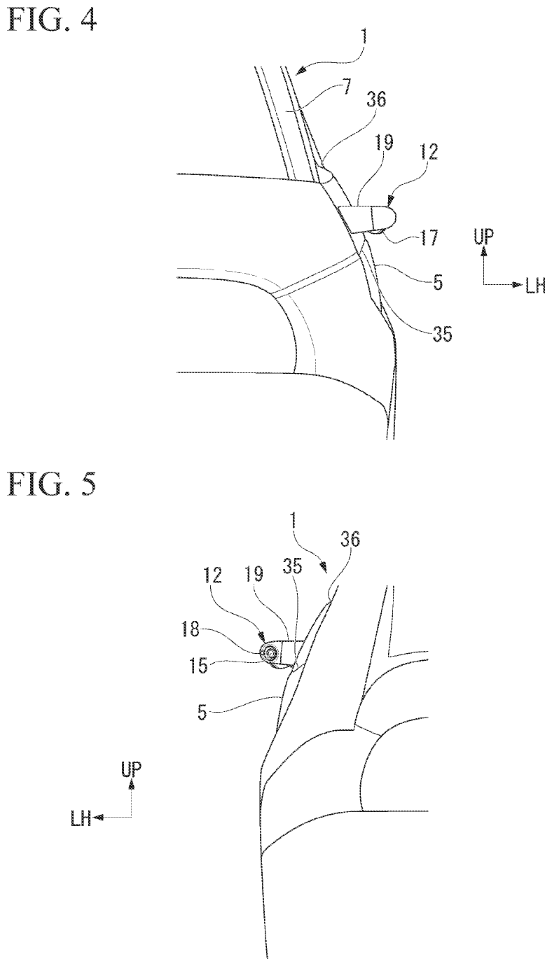

FIG. 2 is a view of the vehicle 1 from the left side, and FIG. 3 is a view of a left half region of the vehicle 1 from above. FIG. 4 is a view of the left half region of the vehicle 1 from a front side, and FIG. 5 is a view of the left half region of the vehicle 1 from a rear side.

As shown in these figures, an imaging unit 12 for a vehicle (hereinafter referred to as “an imaging unit 12”) incorporating the rearward imaging device 15 is attached to an outer surface of the left front side door 5. The same imaging unit 12 as the left imaging unit is also attached to an outer surface of the right front side door 5.

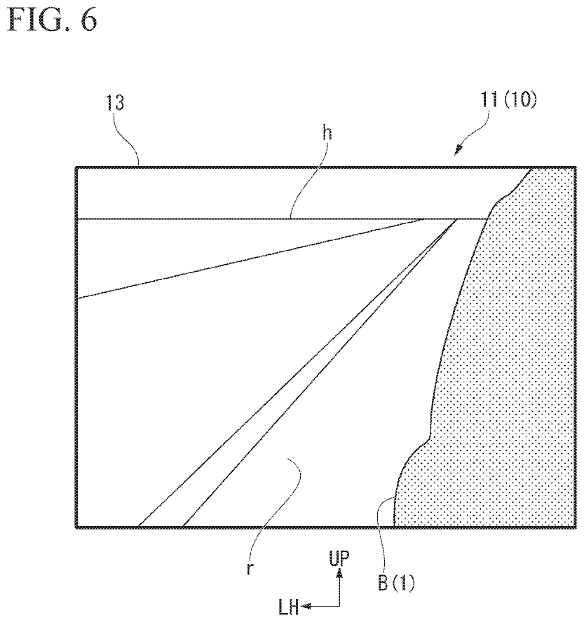

FIG. 6 is a diagram showing a display screen 13 of the monitor 11 installed in the vehicle interior.

The image of the lateral rearward side image captured by the rearward imaging device 15 is projected on the display screen 13 of the monitor 11 together with a part of a vehicle body B on a side portion of the own vehicle. The display screen 13 is set such that, when the vehicle 1 is traveling on a flat road surface, a horizontal line h on the rearward side of the vehicle and a road surface r at a predetermined distance behind the vehicle are simultaneously projected. Imaging targets to be reflected on the display screen 13 are appropriately set according to a size of the display screen 13, an installation height, a position in a front-rear direction, and an angle of view of the rearward imaging device 15, and the like. Further, the amount of reflection of the own vehicle on the display screen 13 is set to, for example, 10% or less of the entire display screen 13.

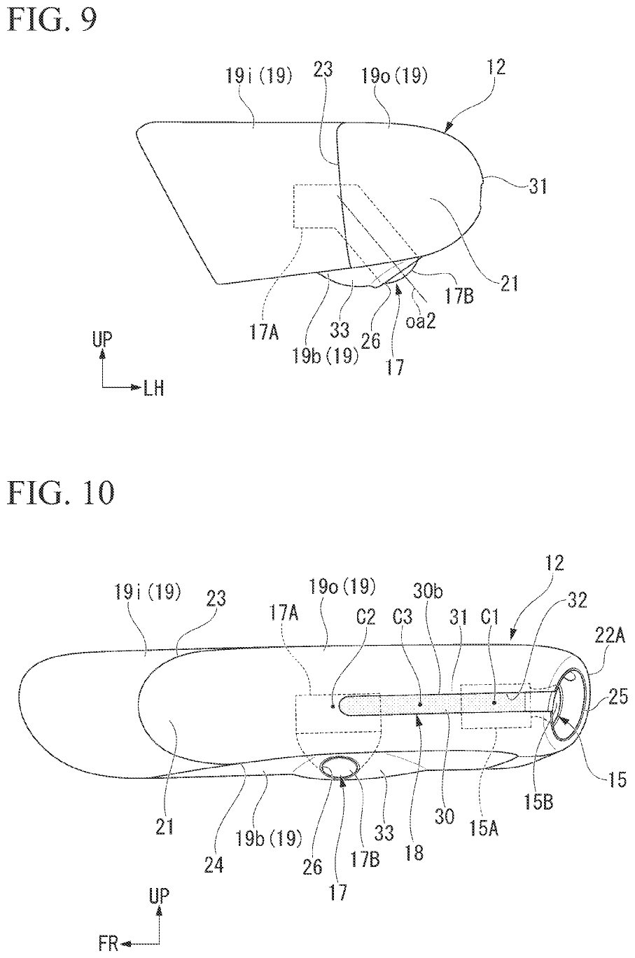

FIG. 7 is a top view of the imaging unit 12 installed on the left front side door 5, and FIG. 8 is a bottom view of the same imaging unit 12. FIGS. 9, 10, and 11 are a front view, a side view, and a rear view of the same imaging unit 12.

As shown in these figures, the imaging unit 12 includes a rearward imaging device 15 that images the lateral rearward side of the vehicle, a downward imaging device 17 that images a lateral downward side of the vehicle, a lamp unit 18 configuring a turn signal lamp, a side lamp, or the like, and a housing 19 that houses them. The housing 19 is attached to an outer surface of the front side door 5 near a front portion via a base member (not shown).

The housing 19 includes an inner housing 19i that is attached to the outer surface (a side portion of the vehicle body) of the front side door 5, an outer housing 190 that is assembled to an outer side of the inner housing 19i in a vehicle width direction, and a bottom housing 19b that is assembled to a bottom opening 20 of the inner housing 19i and the outer housing 19o. The inner housing 19i, the outer housing 19o, and the bottom housing 19b are detachably assembled to each other by screwing, clipping, concave-convex fitting, or the like. The inner housing 19i, the outer housing 19o, and the bottom housing 19b are formed of, for example, a hard resin material.

As shown in FIG. 7, the housing 19 is formed in a substantially trapezoidal shape in a top view in which a width of an outer side b outside in the vehicle width direction is narrower than an inner side a inside in the vehicle width direction which is attached to the front side door 5. A front end of the inner side a and a front end of the outer side b are connected to each other by an inclined side c. The inclined side c is inclined outward in the vehicle width direction from the front end of the inner side a toward a rear side. The inclined side c and the outer side b are connected to each other by a smooth curve. A portion of an outer surface of the housing 19 corresponding to the inclined side c and a curved portion connecting the inclined side c and the outer side b to each other is referred to as an inclined region 21 of the housing 19. Further, a portion of the outer surface of the housing 19 corresponding to a side d connecting rear ends of the inner side a and the outer side b to each other is referred to as a rear end region 22 of the housing 19.

As shown in FIG. 7, a division boundary portion 23 between the inner housing 19i and the outer housing 190 is disposed on an upper surface side of the housing 19. The division boundary portion 23 on the upper surface side of the housing 19 extends in a straight line substantially in a vehicle front-rear direction. The division boundary portion 23 on the upper surface side of the housing 19 is disposed at a position biased outward in the vehicle width direction from a center of the housing in the vehicle width direction (a center line c1 in FIG. 7). Further, an outer surface of the housing 19 is set to have different colors inside and outside in the vehicle width direction with the division boundary portion 23 interposed therebetween. Here, the outer surface of the inner housing 19i and the outer surface of the outer housing 190 are formed by smoothly continuous surfaces with the division boundary portion 23 interposed therebetween.

Further, the division boundary portion 23 between the inner housing 19i and the outer housing 190 extends to a lower surface side across the front and rear ends of the inner housing 19i and the outer housing 19o. As shown in FIG. 8, the above-mentioned opening 20 is in the lower surface of the outer housing 190 to extend outside the division boundary portion 23 in the vehicle width direction. A portion of the opening 20 of the outer housing 190 which extends outward in the vehicle width direction is a division boundary portion 24 between the bottom housing 19b and the outer housing 19o. The bottom housing 19b is detachably assembled across both lower walls of the inner housing 19i and the outer housing 19o.

The rearward imaging device 15 includes a device main body 15A incorporating an image sensor and various processing circuits, and an imaging lens 15B that captures an image of an imaging target. The rearward imaging device 15 is disposed in a rear portion of the housing 19 which is closer to the outside in the vehicle width direction. The imaging lens 15B is exposed outside the vehicle body in a portion of the rear end region 22 of the housing 19 which is closer to the outside in the vehicle width direction. A rear inclined surface 22A directed to the lateral rearward side of the vehicle is provided in a portion of the rear end region 22 of the housing 19 (the outer housing 19o) which is closer to the outside in the vehicle width direction. The rear inclined surface 22A is provided with a first lens exposure hole 25 (a lens disposition portion) for exposing the imaging lens 15B to the outside. As shown in FIG. 7, an optical axis oa1 of the imaging lens 15B faces a rear side of the vehicle while slightly inclined outward in the vehicle width direction.

Further, the downward imaging device 17 is used for a blind monitor system or the like that displays the lateral downward side of the vehicle, which is a blind spot from the driver seat, on a monitor (not shown) on the driver seat side. The downward imaging device 17 includes a device main body 17A incorporating an image sensor and various processing circuits, and an imaging lens 17B that captures an image of an imaging target. The imaging lens 17B is exposed outside the vehicle body on a lower surface of a central region of the housing 19 in the vehicle front-rear direction. The lower surface of the bottom housing 19b is provided with a second lens exposure hole 26 for exposing the imaging lens 17B to the outside. As shown in FIG. 9, an optical axis oa2 of the imaging lens 17B faces the downward side of the vehicle while slightly inclined outward in the vehicle width direction.

Here, as shown in FIG. 7, when the housing 19 is seen from above, the rearward imaging device 15 is located on a rear side of the vehicle with respect to the downward imaging device 17 and is disposed inside the housing 19 such that an outer end of the imaging lens 15B in the vehicle width direction is located outside the downward imaging device 17 in the vehicle width direction. Further, as shown in FIG. 10, the rearward imaging device 15 and the downward imaging device 17 are disposed in the housing 19 such that, in a state in which the housing 19 is attached to a side portion of the front side door 5, positions of centers c1 and c2 of both device main bodies 15A and 17A are substantially horizontal.

As shown in FIG. 7, the lamp unit 18 includes a base block 27 that is attached to an inside of the housing 19, a circuit board 28 that is held by the base block 27, a lamp 29 such as an LED mounted on the circuit board 28, a long light guide body 30 that is held by the base block 27 and guides light of the lamp body 29 to a predetermined portion on the outer surface of the housing 19. The light guide body 30 includes an inclined portion 30a that extends to be inclined outward in the vehicle width direction from the base block 27 toward a rear side of the vehicle body, and a light irradiation portion 30b that extends in a straight line from a rear end of the inclined portion 30a to a rear side of the vehicle.

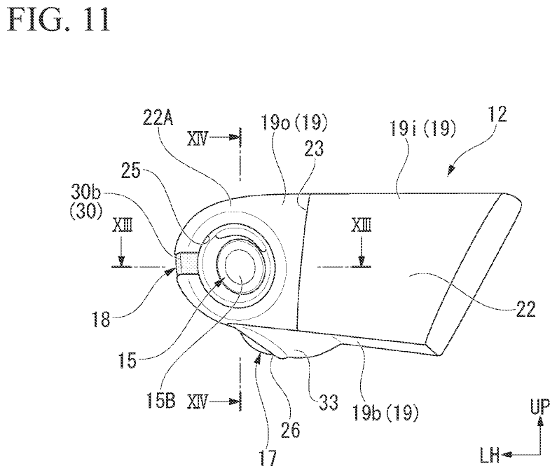

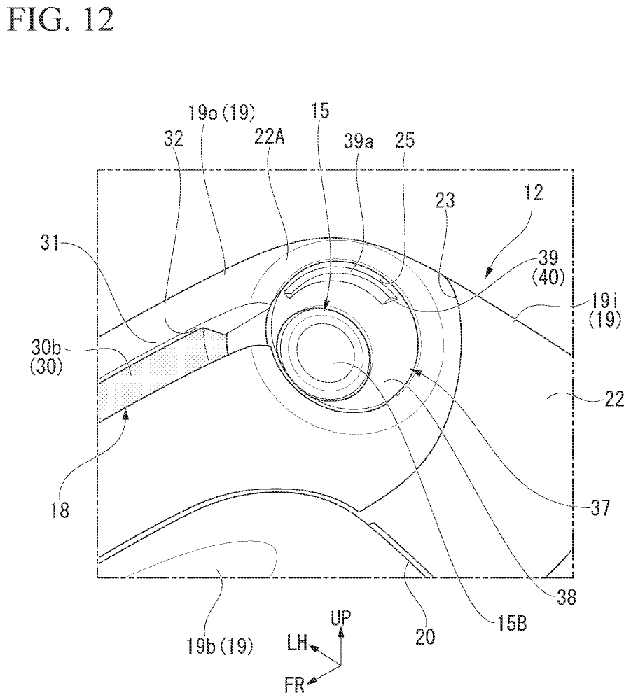

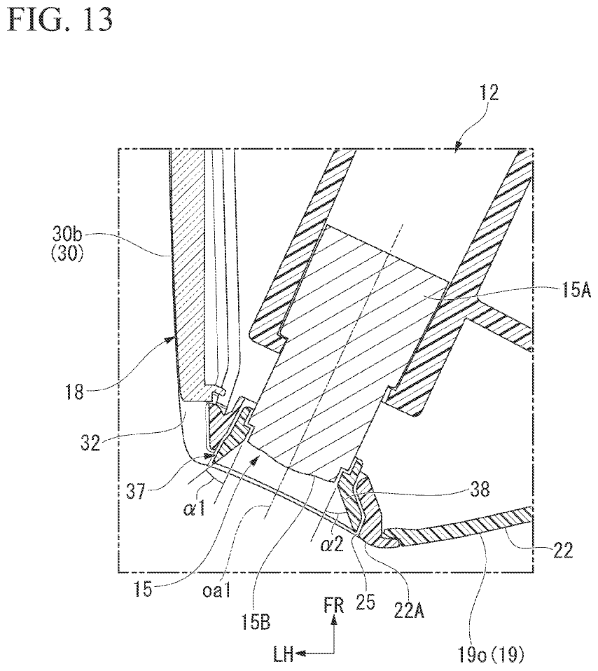

FIG. 12 is a view of the rear end region 22 of the imaging unit 12 from below on the outside in the vehicle width direction, and FIG. 13 is a view showing a cross section along line XIII-XIII of FIG. 11.

The side surface of the housing 19 on the outside in the vehicle width direction is formed with an arc surface curved in a vertical direction. A groove 32 (notch) having a substantially rectangular cross section is formed substantially in a vehicle body front-rear direction in the side surface on the outside in the vehicle width direction at a position slightly below a maximum bulging portion 31 to the outside in the vehicle width direction. The light irradiation portion 30b of the light guide body 30 of the lamp unit 18 is disposed in the groove 32 of the housing 19. A rear end of the light irradiation portion 30b of the light guide body 30 is disposed in the groove 32 of the housing 19 on a front side of a position facing the rear inclined surface 22A. That is, the light irradiation portion 30b is not disposed near a rear end of the groove 32 of the housing 19. Accordingly, it is possible to prevent the light emitted from the light irradiation portion 30b from entering the imaging lens 15B of the rearward imaging device 15.

The rear end of the groove 32 of the housing 19 may be blocked by a member having no light transmission.

On the other hand, the inclined portion 30a of the light guide body 30 of the lamp unit 18, the base block 27, the circuit board 28, the lamp 29, and the like are disposed inside the housing 19. The inclined portion 30a of the light guide body 30 is disposed to substantially follow the inclined region 21 on the outer surface of the housing 19. The downward imaging device 17 is disposed in the housing 19 at a portion inside the inclined portion 30a of the light guide body 30 in the vehicle width direction. The imaging lens 17B of the downward imaging device 17 is inclined obliquely downward from the device main body 17A toward the outside in the vehicle width direction. A portion inclined to an oblique downward side of the imaging lens 17B is disposed in a portion inside the inclined portion 30a of the light guide body 30 in the vehicle width direction. Further, as shown in FIG. 10, the lamp unit 18 is disposed in the housing 19 such that, in a state in which the housing 19 is attached to a side portion of the front side door 5, a center c3 of the lamp unit 18 in the vertical direction is substantially horizontal to the positions of the centers c1 and c2 of the device main bodies 15A and 17A of the rearward imaging device 15 and the downward imaging device 17.

A convex portion 33 that bulges downward is provided in an outer region of the bottom housing 19b in the vehicle width direction. The convex portion 33 is formed in a spindle shape that is long in the vehicle front-rear direction. A second lens exposure hole 26 for exposing the imaging lens 17B of the downward imaging device 17 at a downward side of the bottom housing 19b is formed in the convex portion 33. The second lens exposed hole 26 is disposed in the convex portion 33 at a region that is wider than a width of the second lens exposure hole 26 in the vehicle width direction, for example, a region that is twice a width of the second lens exposure hole 26 or more in the vehicle width direction. The convex portion 33 has a region extending to a rear side of the vehicle with respect to the second lens exposure hole 26 (the imaging lens 17B).

Further, the imaging lens 17B of the downward imaging device 17 is disposed such that an outer surface thereof is continuous with a surface shape of the convex portion 33 of the bottom housing 19b. Further, a rear end of the convex portion 33 that converges in a spindle shape is disposed at a position overlapping a part of the imaging lens 15B of the rearward imaging device 15 in the vehicle width direction.

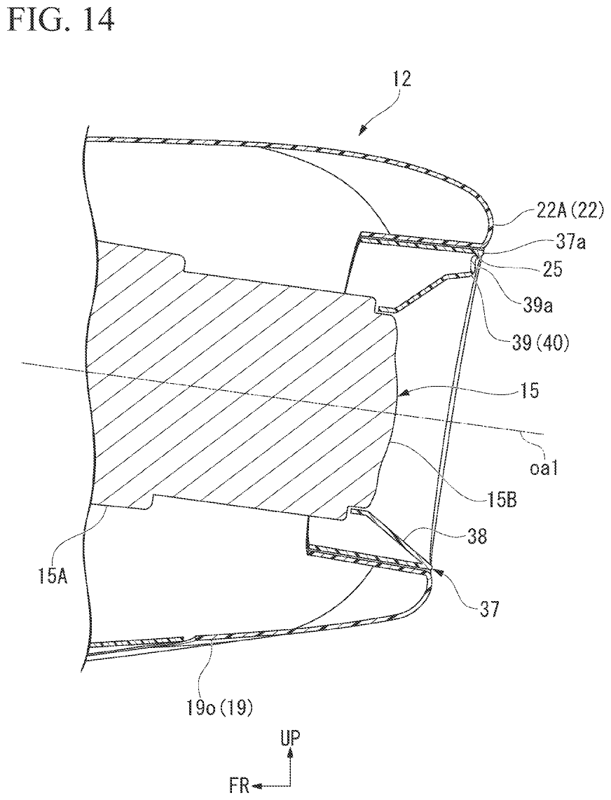

FIG. 14 is a view showing a cross section along line XIV-XIV of FIG. 11.

As shown in FIGS. 12 to 14, a lens hood 37 that covers a peripheral region of the imaging lens 15B of the rearward imaging device 15 is attached to the first lens exposure hole 25 in a rear end of the housing 19 (the outer housing 19o). The lens hood 37 has a truncated conical hood wall 38 that extends to be inclined radially outward from the peripheral region of the imaging lens 15B in an imaging direction. An inclination angle of the hood wall 38 with respect to the optical axis oa1 of the imaging lens 15B is set to be different between an outer region having the groove 32 (the notch) of the housing 19 and an inner region opposite to the outer region with the optical axis oa1 interposed therebetween.

Specifically, as shown in FIG. 13, an inclination angle α1 of the outer region is set to be equal to or larger than an angle of view of the imaging lens 15B and smaller than an inclination angle α2 of the inner region. In a circumferential direction of the hood wall 38, an angular difference between the inclination angle α1 of the inner region and the inclination angle α2 of the outer region is the largest, and the inclination angle continuously changes between the inner region and the outer region. Further, the inclination angle of the hood wall 38 with respect to the optical axis oa1 is set such that a width of the hood wall 38 in a radial direction looks the same between the outer region and the inner region when the housing 19 is seen from the rear side.

Further, as shown in FIGS. 12 and 14, in the hood wall 38 of the lens hood 37, in an upper region of the imaging lens 15B when seen in a direction of the optical axis oa1 of the imaging lens 15B, a step portion 39 having a substantially vertical surface 39a oriented in the imaging direction is formed. The step portion 39 is formed with a ridge 40 that projects in the imaging direction with respect to the inclined surface of the hood wall 38. The ridge 40 is formed in an arc shape substantially along an outer peripheral edge portion of the hood wall 38 when seen in the direction of the optical axis oa1. The ridge 40 can also be formed in an annular shape when seen in the direction of the optical axis oa1.

The ridge 40 (the step portion 39) is formed to be recessed forward from an outer peripheral end 37a (an end in an imaging target direction) of the lens hood 37.

Incidentally, the imaging unit 12 of the present embodiment is disposed at a height, which will be described below, of the side portion of the vehicle 1.

Hereinafter, a description will be made with reference to FIG. 2. In FIG. 2, reference numeral 35 is a character line on the side portion of the vehicle body, and reference numeral 36 is a door waist portion. The character line 35 is a convex ridge line portion provided on the outer surface of the side portion of the vehicle body including the front side door 5 in a raised manner and extends substantially in the vehicle front-rear direction. Further, the door waist portion 36 is an upper side portion of a door body of the front side door 5, and constitutes a lower side in the exterior of the window frame portion in which the door glass 6 is raised and lowered.

The imaging unit 12 is disposed above a height h1 of the character line 35 of the front side door 5 and in a height range of 925 mm or more from the ground and a maximum vehicle height h2 or less. Therefore, as shown in FIG. 2, droplets s that front wheels Wf of the own vehicle spatter when the vehicle is traveling are blocked by the raised portion of the character line 35 and are unlikely to adhere to the imaging unit 12.

In the case of the present embodiment, since the installation height of the imaging unit 12 is set to 925 mm or more from the ground, halation due to light from headlights of a following vehicle is unlikely to occur. That is, in the present embodiment, since the imaging unit 12 is disposed at a height of 925 mm or more in consideration of downward inclination of an optical axis of the headlights with respect to 950 mm which is the maximum installation height of headlights of a general vehicle used on public roads, it is possible to prevent the light from the headlights of a following vehicle from directly entering the rearward imaging device 15 and causing halation in the image on the monitor 11.

Further, in the case of the present embodiment, the imaging unit 12 is disposed at a position lower than the door waist portion 36 of the front side door 5. Therefore, it is difficult for the imaging unit 12 to enter a field of view of the driver through the window frame portion of the front side door 5.

Further, as shown in FIG. 2, a retractable flush door handle 45 is provided in the rear edge portion of the outer surface of the front side door 5. The flush door handle 45 is formed in a horizontally long rectangular shape in a vehicle side view. The imaging unit 12 attached to a front edge portion of the outer surface of the front side door 5 is formed in a horizontally long rectangular shape having the same size and substantially the same shape as the flush door handle 45 in the vehicle side view. The imaging unit 12 and the flush door handle 45 are disposed at point-symmetrical positions centered on a point on the character line 35 in the vehicle side view.

As described above, in the imaging unit 12 of the present embodiment, the rearward imaging device 15 is located on a rear side of the vehicle with respect to the downward imaging device 17 and is disposed inside the housing 19 such that an outer end of the imaging lens 15B in the vehicle width direction is located outside the downward imaging device 17 in the vehicle width direction. Therefore, in the imaging unit 12 of the present embodiment, it is possible to suppress mutual reflection of the rearward imaging device 15 and the downward imaging device 17, to make the housing 19 compact in the vehicle width direction, to suppress reflection of the own vehicle by the rearward imaging device 15, and to image a region including a rearward far side of the vehicle by the rearward imaging device 15. That is, in the present embodiment, since the imaging lens 15B of the rearward imaging device 15 is disposed behind the downward imaging device 17 and outside the downward imaging device 17 in the vehicle width direction, at a position separated from the side portion of the vehicle body of the own vehicle, a rearward region including the rearward far side of the vehicle can be imaged through the imaging lens 15B.

Therefore, in a case in which the imaging unit 12 of the present embodiment is employed, the rearward imaging device 15 and the lateral imaging device 17 can be stored compactly in one housing 19 without limiting functions of the rearward imaging device 15 and the downward imaging device 17.

Further, in the imaging unit 12 of the present embodiment, the rearward imaging device 15 and the downward imaging device 17 are disposed in the housing 19 such that, in a state in which the housing 19 is attached to the side portion of the vehicle body, positions of centers c1 and c2 of both device main bodies 15A and 17A are substantially horizontal. Therefore, a thickness of the housing 19 in the vertical direction can be reduced, and traveling resistance of the housing 19 can be reduced when the vehicle travels.

Further, in the imaging unit 12 of the present embodiment, the lamp unit 18 of a turn light, a side lamp, or the like is integrally attached to an outer portion of the housing 19 in the vehicle width direction. Therefore, the lamp unit 18 is disposed inside one housing 19 together with the rearward imaging device 15 and the downward imaging device 17 in an integrative manner. Thus, in a case in which the configuration of the present embodiment is employed, the number of components can be further reduced and the unit can be downsized.

Further, in the imaging unit 12 of the present embodiment, the lamp unit 18 is attached to the housing 19 such that, in a state in which the housing 19 is attached to the side portion of the vehicle body, the position of the center c3 of the lamp unit 18 in the vertical direction is substantially horizontal to the positions of the centers c1 and c2 of the rearward imaging device 15 and the downward imaging device 17. Therefore, the thickness of the housing 19 in the vertical direction can be reduced, while the lamp unit 18 is incorporated in one housing 19 together with the rearward imaging device 15 and the downward imaging device 17. Thus, in a case in which the configuration of the present embodiment is employed, the traveling resistance of the housing 19 can be reduced when the vehicle travels.

Further, in the imaging unit 12 of the present embodiment, the outer surface of the housing 19 is provided with the inclined region 21 that extends to be inclined outward in the vehicle width direction from a front end position close to the front side door 5 toward a rear side of the vehicle body. Then, the inclined portion 30a of the light guide body 30 of the lamp unit 18 is assembled to the housing 19 to substantially follow the inclined region 21, and the downward imaging device 17 is disposed at an inner position of the inclined portion 30a in the vehicle width direction. Therefore, it is possible to reduce the traveling resistance when the vehicle travels due to the inclined region 21 on a front side of the housing 19 and to make the housing 19 compact while avoiding interference between the lamp unit 18 and the downward imaging device 17 inside the housing 19. That is, in the present embodiment, since the downward imaging device 17 is disposed inside in the vehicle width direction with respect to the outer end of the imaging lens 17B of the rearward imaging device 17 in the vehicle width direction, interference between the inclined portion 30a of the lamp unit 18 and the downward imaging device 17 can be easily avoided.

In particular, in the imaging unit 12 of the present embodiment, since the imaging lens 17B of the downward imaging device 17 is disposed inside the housing 19 to be inclined outward in the vehicle width direction and downward from the device main body 17A, interference between the imaging lens 17B of the downward imaging device 17 and the inclined portion 30a of the lamp unit 18 can be more easily avoided.

The present invention is not limited to the above embodiment, and various design changes can be made without departing from the gist thereof.

### REFERENCE SIGNS LIST

12 Imaging unit (imaging unit for vehicle)
15 Rearward imaging device
15B Imaging lens
17 Downward imaging device
17A Device main body
17B Imaging lens
18 Lamp unit
19 Housing
21 Inclined region
30 Inclined portion

1. An imaging unit for a vehicle comprising:
a rearward imaging device that images a lateral rearward side of the vehicle;
a downward imaging device that images a lateral downward side of the vehicle; and
a housing in which the rearward imaging device and the downward imaging device are housed and that is attached to a side portion of a vehicle body,
wherein the rearward imaging device is located on a rear side of the vehicle with respect to the downward imaging device and is disposed inside the housing such that an outer end of an imaging lens in a vehicle width direction is located outside the downward imaging device in the vehicle width direction, and the rearward imaging device and the downward imaging device are disposed to overlap each other in at least a part thereof in a vehicle front-rear direction.

2. The imaging unit for a vehicle according to claim 1, wherein the rearward imaging device and the downward imaging device are disposed in the housing such that, in a state in which the housing is attached to the side portion of the vehicle body, center positions of both device main bodies are substantially horizontal.

3. The imaging unit for a vehicle according to claim 1 or 2, wherein a lamp unit that emits light to the outside is attached to an outer portion of the housing in the vehicle width direction.

4. The imaging unit for a vehicle according to claim 3, wherein the lamp unit is attached to the housing such that, in a state in which the housing is attached to the side portion of the vehicle body, a center position of the lamp unit in the vertical direction is substantially horizontal to center positions of device main bodies of the rearward imaging device and the downward imaging device.

5. The imaging unit for a vehicle according to claim 3,
wherein an outer surface of the housing has an inclined region that extends to be inclined outward in the vehicle width direction from a front end position close to a vehicle body side surface toward a rear side of the vehicle body,
wherein the lamp unit has an inclined portion that is disposed in the housing substantially along the inclined region, and
wherein the downward imaging device is disposed at a position inside the inclined portion in the vehicle width direction.

6. The imaging unit for a vehicle according to claim 5, wherein the downward imaging device is disposed inside the housing such that an imaging lens is inclined outward in the vehicle width direction and downward from the device main body.

7. The imaging unit for a vehicle according to claim 3, wherein the lamp unit is disposed outside in the vehicle width direction with respect to the rearward imaging device and the downward imaging device.
